(19) United States
(12) Patent Application Publication
(10) Pub. No.: US 2025/0250134 A1
(43) Pub. Date: Aug. 7, 2025

(54) MEDIUM PROCESSING APPARATUS, IMAGE FORMING APPARATUS, AND IMAGE FORMING SYSTEM

(71) Applicant: Yuuki Nakagawa, KANAGAWA (JP)

(72) Inventor: Yuuki Nakagawa, KANAGAWA (JP)

(73) Assignee: Ricoh Company, Ltd., Tokyo (JP)

(21) Appl. No.: 19/020,062

(22) Filed: Jan. 14, 2025

(30) Foreign Application Priority Data
Feb. 1, 2024 (JP) 2024-014076

(51) Int. Cl. B65H 9/00; B41J 3/44; B41J 11/00; B65H 5/06; B65H 5/24; B65H 29/20; B65H 37/06

(52) U.S. Cl. CPC B65H 9/002; B41J 3/44; B41J 11/0015; B65H 5/062; B65H 5/24; B65H 29/20; B65H 37/06; B65H 2301/3613; B65H 2301/443246; B65H 2301/45; B65H 2801/27

(57) ABSTRACT

A medium processing apparatus includes a first conveyor and a second conveyor. The first conveyor is disposed in a conveyance path to convey a medium or multiple media including the medium in a conveyance direction. The second conveyor is disposed in a circulation path that is branched from the conveyance path at a branching point and is merged at a merging point upstream from the branching point in the circulation path in the conveyance direction to circulate the medium. The second conveyor includes a correction roller pair to correct a displacement of the multiple media that are overlaid on each other and circulate together in the circulation path.

### CROSS-REFERENCE TO RELATED APPLICATION

This patent application is based on and claims priority pursuant to 35 U.S.C. § 119(a) to Japanese Patent Application No. 2024-014076, filed on Feb. 1, 2024, in the Japan Patent Office, the entire disclosure of which is hereby incorporated by reference herein.

### BACKGROUND

### Technical Field

Embodiments of the present disclosure relate to a medium processing apparatus, an image forming apparatus, and an image forming system.

### Background Art

Various types of medium processing apparatuses are known that perform post-processing operations including an alignment operation for aligning a bundle of overlaid sheet-shaped recording media (“sheets”) and a sheet folding operation for folding a sheet or a bundle of sheets. Further, various types of image forming apparatuses are known that have a function corresponding to the medium processing apparatus and a function of image formation are also known. In addition, various types of image forming systems are also known that include a medium processing apparatus and an image forming apparatus in separate housings, and couple the medium processing apparatus and the image forming apparatus to operate in conjunction with each other.

Further, a correction technique is known that, when overlaying multiple sheets, skew of the multiple sheets is corrected by contacting the leading end of each of the multiple sheets (in the conveyance direction) to the nip region of a conveyance roller pair.

The above-described known technique has an inconvenience when the technique is applied to multiple sheets overlaid with each other by a circulating conveyance operation. Specifically, when the sheets overlaid with each other are conveyed in the circulating conveyance operation, the leading end of each sheet of the sheets overlaid with each other is displaced again due to the difference between the distances of an inner route and an outer route in a conveyance path, and it is difficult to handle such an inconvenience.

### SUMMARY

Embodiments of the present disclosure described herein provide a novel medium processing apparatus including a first conveyor and a second conveyor. The first conveyor is disposed in a conveyance path to convey a medium or multiple media including the medium in a conveyance direction. The second conveyor is disposed in a circulation path that is branched from the conveyance path at a branching point and is merged at a merging point upstream from the branching point in the circulation path in the conveyance direction to circulate the medium. The second conveyor includes a correction roller pair to correct a displacement of the multiple media that are overlaid on each other and circulate together in the circulation path.

Further, embodiments of the present disclosure described herein provide an image forming apparatus including an image forming device to form an image on a medium, and the above-described medium processing apparatus to perform a given operation on the medium.

Further, embodiments of the present disclosure described herein provide an image forming system including an image forming apparatus to form an image on a medium, and the above-described medium processing apparatus detachably attachable to the image forming apparatus.

### BRIEF DESCRIPTION OF THE SEVERAL VIEWS OF THE DRAWINGS

Exemplary embodiments of this disclosure will be described in detail based on the following figures, wherein:

FIG. 1 is a side view of an image forming apparatus including a medium processing apparatus according to an embodiment of the present disclosure;

FIG. 2 is a diagram illustrating a schematic configuration of an image forming system according to an embodiment of the present disclosure;

FIG. 3 is a block diagram illustrating a control configuration of the image forming system according to an embodiment of the present disclosure;

FIG. 4 is a diagram illustrating an internal configuration of a sheet folder unit as a medium processing apparatus according to an embodiment of the present disclosure;

FIGS. 5A, 5B, 5C and 5D are diagrams illustrating examples of folding patterns executable by the sheet folder unit of FIG. 4;

FIGS. 6A, 6B, 6C, 6D, 6E, 6F, 6G and 6H are diagrams illustrating examples of a folding conveyance operation by the sheet folder unit of FIG. 4;

FIGS. 7A, 7B, 7C, 7D, 7E, 7F, 7G and 7H are diagrams illustrating different examples of the folding conveyance operation by the sheet folder unit of FIG. 4;

FIGS. 8A, 8B, 8C, 8D, 8E, 8F, 8G and 8H are diagrams illustrating different examples of the folding conveyance operation by the sheet folder unit of FIG. 4;

FIGS. 9A, 9B, 9C, 9D, 9E, 9F, 9G, 9H and 9I are diagrams illustrating different examples of the folding conveyance operation by the sheet folder unit of FIG. 4;

FIG. 10 is an enlarged view of the internal configuration of the sheet folder unit, illustrating a process of the folding conveyance operation by the sheet folder unit of FIG. 4;

FIG. 11 is an enlarged view of the internal configuration of the sheet folder unit, illustrating a process of the folding conveyance operation subsequent to the process of FIG. 10, by the sheet folder unit of FIG. 4;

FIG. 12 is an enlarged view of the internal configuration of the sheet folder unit, illustrating a process of the folding conveyance operation subsequent to the process of FIG. 11, by the sheet folder unit of FIG. 4;

FIG. 13 is an enlarged view of the internal configuration of the sheet folder unit, illustrating a process of the folding conveyance operation subsequent to the process of FIG. 12, by the sheet folder unit of FIG. 4;

FIG. 14 is an enlarged view of the internal configuration of the sheet folder unit, illustrating a process of the folding conveyance operation subsequent to the process of FIG. 13, by the sheet folder unit of FIG. 4; and

FIG. 15 is an enlarged view of the internal configuration of the sheet folder unit, illustrating a process of the folding conveyance operation subsequent to the process of FIG. 14, by the sheet folder unit of FIG. 4.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Identical reference numerals are assigned to identical or equivalent components and a description of those components may be simplified or omitted.

### Embodiment of Image Forming Apparatus

A description is given of an image forming apparatus according to an embodiment of the present disclosure.

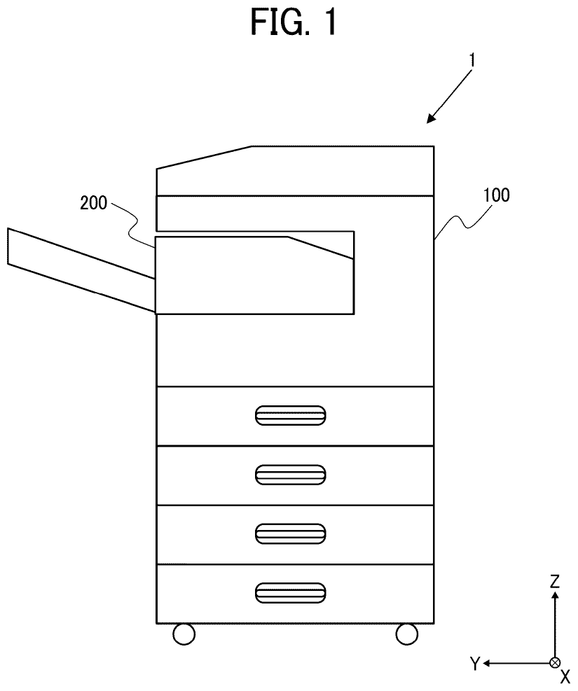

FIG. 1 is an external view of an image forming apparatus 1 according to an embodiment of the present disclosure.

The image forming apparatus 1 according to the present embodiment includes an image formation unit 100 that functions as an image formation device and a sheet folder unit 200 that functions as a medium processing apparatus. The sheet folder unit 200 is a unit that operates in cooperation with the image formation unit 100. The image formation unit 100 illustrated in FIG. 1 is an in-body ejection type image formation unit. The image formation unit 100 has a function of making the sheet folder unit 200 selectable as an ejection destination of a medium having an image on the surface.

The sheet folder unit 200 serving as a medium processing apparatus according to an embodiment of the present disclosure has a function of making a sheet bundle Q that is multiple sheets P overlaid with each other. As will be described below, the sheet folder unit 200 has a function of performing a circulating conveyance on the sheet P and overlaying multiple sheets P with each other before forming the sheet bundle Q. The internal configuration of the sheet folder unit 200 to execute the functions is described below.

### Embodiment of Image Forming System

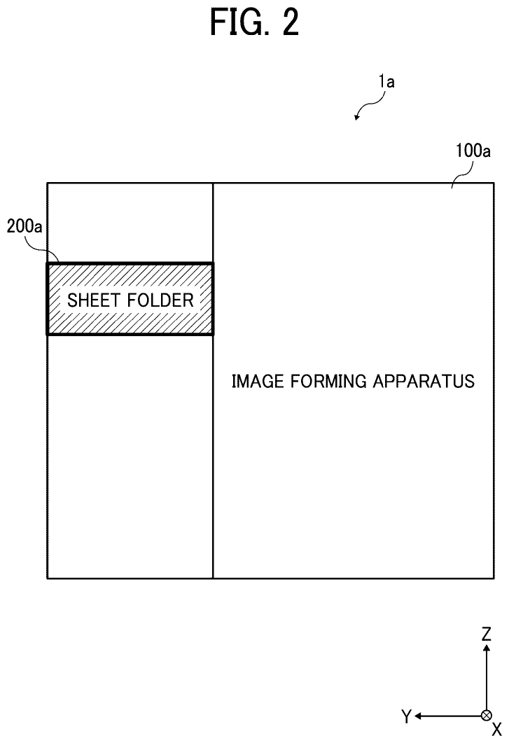

FIG. 2 is a diagram illustrating a schematic configuration of an image forming system 1a according to an embodiment of the present disclosure.

The image forming system 1a according to the present embodiment includes an image forming apparatus 100a and a sheet folder 200a as a medium processing apparatus. The image forming apparatus 100a and the sheet folder 200a are coupled to each other. The image forming system 1a operates such that the sheets P on each of which an image is formed by the image forming apparatus 100a is conveyed to the sheet folder 200a and a given multiple folding process is executed on the sheets P in the sheet folder 200a.

### Functional Configuration of Control Block

A description is given of the control block that controls the operations of the image formation unit 100 and the sheet folder unit 200 serving as a medium processing apparatus, according to the present embodiment, with reference to FIG. 3.

FIG. 3 is a block diagram illustrating the control configuration of the image forming system 1 as an image forming system of FIG. 2.

As illustrated in FIG. 3, the image formation unit 100 includes a printer controller 110 as a control block. The printer controller 110 includes a central processing unit (CPU) 111, a read-only memory (ROM) 112, a random access memory (RAM) 113, and a serial interface (serial I/F) 114.

The printer controller 110 is connected to an image forming device 120, an image reading device 130, and a control panel 140. Each of the image forming device 120, the image reading device 130, and the control panel 140 includes components to fully perform the functions. Each component of the image forming device 120, the image reading device 130, and the control panel 140 operates based on a control signal issued by the printer controller 110.

The image forming device 120 performs an image forming operation based on image data on a sheet P that serves as a recording medium or a sheet-like recording medium. The image reading device 130 reads an image formed on the sheet P and acquires the image data of the image on the sheet P. The control panel 140 functions as an input unit via which operating conditions in the image forming device 120 and the image reading device 130 are input and as a display unit that displays, for example, the operation results.

The control panel 140 also functions as a display unit related to processing contents executed by the sheet processing controller 210 and an input unit that receives input of setting information for controlling the operation (behavior) of the sheet folder unit 200.

The ROM 112 stores control programs for controlling the image forming device 120, the image reading device 130, and the control panel 140. The CPU 111 reads the control programs stored in the ROM 112 to the RAM 113. Then, the CPU 111 stores data in the RAM 113 to use the data for the control and executes the control defined by the control programs while using the RAM 113 as a work area.

As illustrated in FIG. 3, the sheet folder unit 200 includes the sheet processing controller 210 as a control block. The sheet processing controller 210 includes a central processing unit (CPU) 211, a read-only memory (ROM) 212, a random access memory (RAM) 213, and a serial interface (serial I/F) 214.

The sheet processing controller 210 is connected to various components 220 and various sensors 240.

The various components 220 are, for example, rollers and roller pairs (pair of rollers) described below. The rollers and roller pairs corresponding to the various components 220 include sheet conveyance roller pairs, a leading-end-alignment conveyance roller pair, a displacement correction conveyance roller pair, and sheet folding roller pairs. The various components 220 are operated by a drive motor that rotates and drives at least one of rollers of each roller pair. The sheet processing controller 210 controls a driver 230 to drive the drive motor that drives the various components 220. The various components 220 performs operations such as a conveyance control of the sheet P as a recording medium and a sheet folding operation on the sheet P.

The various sensors 240 are sheet detectors that detect a position of a sheet at a position in a conveyance path. The various sensors 240 are arranged side by side along the conveyance path for performing conveyance or circulating conveyance. To detect the amount of conveyance and position of a sheet P or a sheet bundle Q, which are objects to be processed, the various sensors 240 output signals to the sheet processing controller 210 when the amount of conveyance and position are detected. The sheet processing controller 210 determines the positions of the sheet P and the sheet bundle Q by the given control program based on the detection signals sent from the various sensors 240 and controls the execution of an appropriate process. The sheet processing controller 210 calculates the position of the sheet P based on the amount of movement of the various components 220 and the amount of conveyance (i.e., the distance of conveyance) of the sheet P from when the leading end of the sheet P is detected by the sheet detector.

The ROM 212 stores the control program for the sheet processing controller 210 to perform predetermined processing. The CPU 211 reads the control programs stored in the ROM 212 to the RAM 213. Then, the CPU 211 stores data in the RAM 213 to use the date for the control and executes the control of the sheet folding operation defined by the control programs while using the RAM 213 as a work area. As described above, the sheet processing controller 210 executes the control program stored in the ROM 212, detection of the sheet P and conveyance control on the sheet P can be executed, as described below.

The printer controller 110 provided with the image formation unit 100 and the sheet processing controller 210 provided with the sheet folder unit 200 are communicably connected to each other via the serial I/F 114 and the serial I/F 214. This communication passage is used to exchange control commands and information to be used, for example, for conveyance control of the recording medium, between the printer controller 110 and the sheet processing controller 210. The sheet folder unit 200 determines whether the conveyance control of a recording medium and the sheet folding operations are performed on the sheet P and switches the kinds of the sheet folding operation, based on the control commands and information related to the sheet P both being sent from the image formation unit 100 and information related to the position of the sheet P as a recording medium obtained from the various sensors 240.

The information related to the sheet P that is sent from the image formation unit 100 (the printer controller 110) to the sheet folder unit 200 (the sheet processing controller 210) includes multiple kinds of information. For example, the information includes the sheet type information of multiple sheets such as the kind, thickness, and size of the sheet P to be conveyed from the image formation unit 100 to the sheet folder unit 200. The information related to the sheet P also includes, for example, information indicating the kind of the post-processing operation (for example, whether the post-processing operation is the sheet folding operation or the multiple folding operation), information indicating the number of sheets P included in the sheet bundle on which the sheet folding operation is performed, and information indicating the sheet folding position at which the sheet folding operation is performed on the sheet P. The control commands sent from the printer controller 110 to the sheet processing controller 210 include a command indicating whether the sheet P that is conveyed is the last page (final sheet) in a unit of which the sheets P to be conveyed are collectively processed, in other words, a command corresponding to the “notification of the start of sheet folding”.

### Embodiment of Medium Processing Apparatus

A description is given of the internal configuration of the sheet folder unit 200 as a medium processing apparatus according to a first embodiment of the present disclosure.

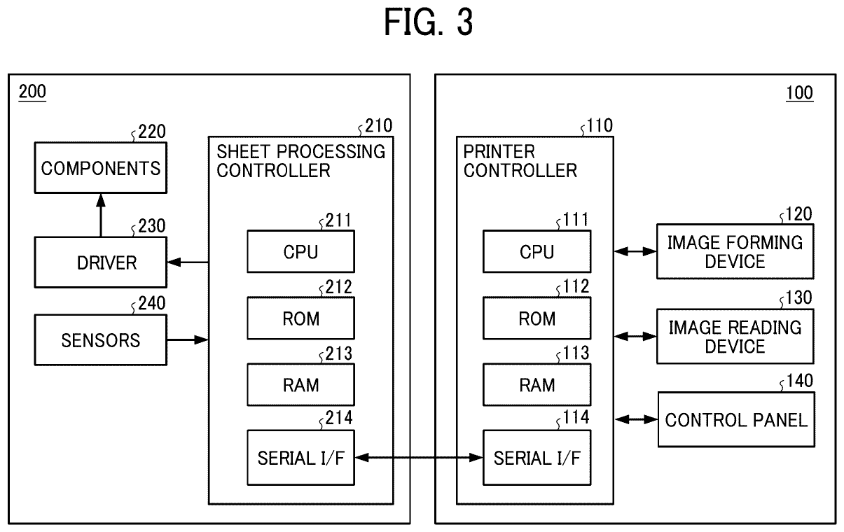

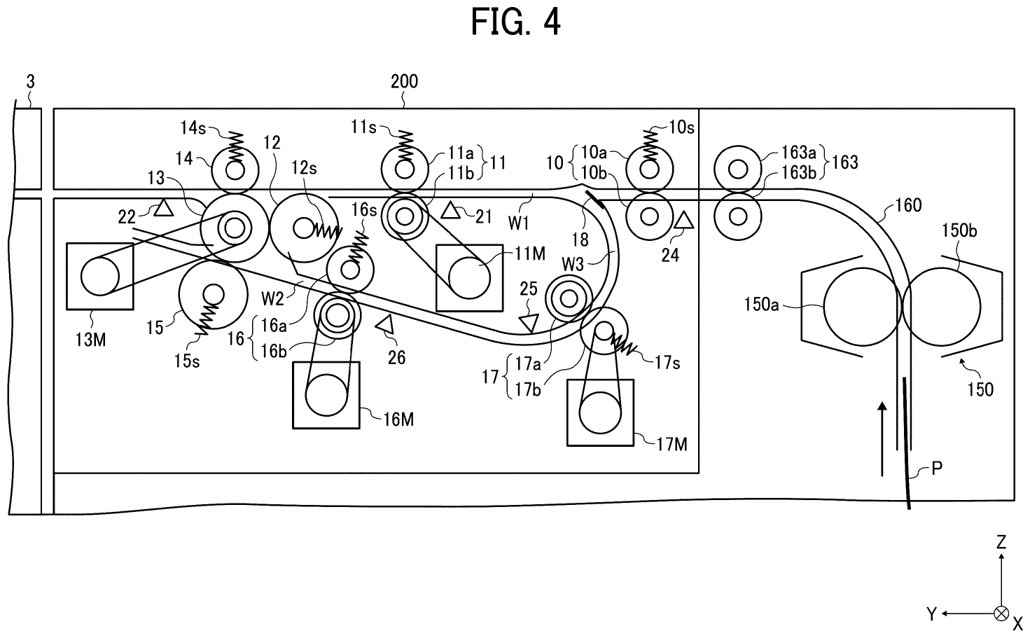

FIG. 4 is a schematic diagram illustrating the internal configuration of the sheet folder unit 200.

The sheet folder unit 200 according to the present embodiment includes a non-folding conveyance path W1 to convey the sheet P to a post-processing apparatus 3 downstream from the sheet folder unit 200 in the conveyance direction, without performing the sheet folding operation on the sheet P ejected from the image formation unit 100. The sheet folder unit 200 further includes a branched conveyance path W2 branched from the non-folding conveyance path W1. After the sheet folding operation is performed on the sheet P ejected from the image formation unit 100, the sheet P is conveyed in the branched conveyance path W2 to the post-processing apparatus 3 downstream from the sheet folder unit 200 in the conveyance direction. The sheet folder unit 200 further includes a circulating conveyance path W3 branched from the non-folding conveyance path W1. The sheet P that is conveyed via a skew correction roller pair 11, a roller pair including a first folding roller 12 and a first forward-reverse roller 13, and a second forward-reverse roller pair 16 is brought to temporarily stand by in the circulating conveyance path W3 as a receiving portion in which the stand-by sheet P is overlaid on subsequent sheet or sheets ejected from the image formation unit 100.

An entrance roller pair 10 is disposed at the entrance side of the non-folding conveyance path W1 that receives the sheet P ejected from the image formation unit 100. The entrance roller pair 10 includes a pressure roller 10a that is a rotary member and a drive roller 10b that is an opposing member. The drive roller 10b is driven and rotated by a driving force of an entrance motor that is a drive source.

Further, a skew correction roller pair 11 is disposed downstream from the entrance roller pair 10 in the non-folding conveyance path W1 in the sheet conveyance direction. The skew correction roller pair 11 is a leading-end-alignment conveyance roller pair as a first conveyor. The skew correction roller pair 11 includes a pressure roller 11a that is a rotary member and a drive roller 11b that is an opposing member. The drive roller 11b is driven and rotated by a driving force of a skew forward-reverse motor 11m that is a drive source that can drive forward and reverse rotations.

Further, a first folding roller 12, a first forward-reverse roller 13 in contact with the first folding roller 12, and a pressing roller 14 in contact with the first forward-reverse roller 13 are disposed on the exit side of the non-folding conveyance path W1. As the sheet P passes through the nip region between the first folding roller 12 and the first forward-reverse roller 13, the sheet P can move from the non-folding conveyance path W1 to the branched conveyance path W2.

Further, as the sheet P passes through the nip region between the first forward-reverse roller 13 and the pressing roller 14, the sheet P can be conveyed to the post-processing apparatus 3 disposed downstream from the nip region of the first forward-reverse roller 13 and the pressing roller 14 via the non-folding conveyance path W1. Further, in the present embodiment, a second folding roller 15 in contact with the first forward-reverse roller 13 is disposed on the exit side of the branched conveyance path W2. Further, a second forward-reverse roller pair 16 is disposed opposite to the second folding roller 15 across the nip region of the first folding roller 12 and the first forward-reverse roller 13 into which the sheet P conveyed from the non-folding conveyance path W1 enters. The second forward-reverse roller pair 16 includes a pressure roller 16a that is a rotary member and a drive roller 16b that is an opposing member. The drive roller 16b is driven and rotated by a driving force of a skew forward-reverse motor 11m that is a drive source that can drive forward and reverse rotations.

The first forward-reverse roller 13 can be rotationally driven in forward and reverse directions by the driving force of a first forward-reverse motor 13m that is rotatable in both forward and reverse directions. The first folding roller 12, the pressing roller 14, and the second folding roller 15, which are disposed in contact with the first forward-reverse roller 13, are driven rollers that are driven to rotate in accordance with the rotation of the first forward-reverse roller 13.

Further, the drive roller 16b of the second forward-reverse roller pair 16 can be driven and rotated in the forward and reverse directions by the driving force of the second forward-reverse motor 16m that is rotatable in both forward and reverse directions. The pressure roller 16a of the second forward-reverse roller pair 16 is a driven roller that is driven and rotated in accordance with the rotation of the driving roller 16a.

Further, in the present embodiment, a second skew correction roller pair 17 as a displacement-correction conveyance roller pair in the circulating conveyance path W3. The second skew correction roller pair 17 includes a pressure roller 17a that is a rotary member and a drive roller 17b that is an opposing member. The drive roller 17b is driven and rotated by a driving force of a second skew correction motor 17m that is a drive source that can drive forward and reverse rotations.

A film 18 is disposed at a branching point at which the circulating conveyance path W3 and the non-folding conveyance path W1 branch. The film 18 has a leading end disposed on the side of the non-folding conveyance path W1.

In the present embodiment, these driven rollers have respective roller shafts that are biased by pressure springs 10s, 11s, 12s, 14s, 15s, 16s and 17s as biasing force appliers, so that the driven rollers form respective nip regions with the corresponding opposing rollers.

Further, in the present embodiment, an entrance sensor 24 is disposed upstream from the entrance roller pair 10 in the sheet conveyance direction (on the entrance side of the non-folding conveyance path W1). The entrance sensor 24 functions as a sheet end detector to detect the end of the sheet P. When the leading or trailing end of a sheet P conveyed from the image formation unit 100 reaches the detection area of the entrance sensor 24, the entrance sensor 24 outputs a detection signal indicating the arrival of the leading or trailing end of the sheet P, to the controller. As an example of the entrance sensor 24, a known sensor can be used.

Further, in the present embodiment, a skew sensor 21 is disposed upstream from the skew correction roller pair 11 in the sheet conveyance direction (near the center portion of the non-folding conveyance path W1). The skew sensor 21 functions as a sheet end detector to detect the end of a sheet P. When the leading end of the sheet P conveyed from the image formation unit 100 reaches the detection area of the skew sensor 21, the skew sensor 21 outputs a leading end detection signal indicating the arrival of the leading end of the sheet P, to the controller. As an example of the skew sensor 21, a known sensor can be used.

Further, in the present embodiment, a sheet detection sensor 22 is disposed downstream from the second conveyor including the first forward-reverse roller 13 and the pressing roller 14 in the sheet conveyance direction (on the exit side of the non-folding conveyance path W1). The sheet detection sensor 22 functions as a sheet leading end detector to detect the leading end of a sheet P. When the leading end of the sheet P conveyed from the non-folding conveyance path W1 reaches the detection area of the sheet detection sensor 22, the sheet detection sensor 22 outputs a leading end detection signal indicating the arrival of the leading end of the sheet P, to a sheet processing controller 210. Similarly to the skew sensor 21 described above, a known sensor can be used as an example of the sheet detection sensor 22.

Further, in the present embodiment, a sheet detection sensor 26 is disposed downstream from the second forward-reverse roller pair 16 in the sheet conveyance direction (on the opposite side of the exit side of the branched conveyance path W2). The sheet detection sensor 26 detects the leading end of a sheet P. When the leading end of the sheet P conveyed from the non-folding conveyance path W1 to the branched conveyance path W2 reaches the detection area of the sheet detection sensor 26, the sheet detection sensor 22 outputs a leading end detection signal indicating the arrival of the leading end of the sheet P, to the sheet processing controller 210. Similarly to the entrance sensor 24, the skew sensor 21, and the sheet detection sensor 22 described above, a known sensor can be used as an example of the sheet detection sensor 26.

Further, in the present embodiment, a circulation sensor 25 is disposed downstream from the second skew correction roller pair 17 as a circulating conveyance roller pair in the sheet conveyance direction. The circulation sensor 25 detects the leading end of the sheet P. When the leading end of the sheet P conveyed from the non-folding conveyance path W1 to the branched conveyance path W2 reaches the detection area of the circulation sensor 25, the circulation sensor 25 outputs a leading end detection signal indicating the arrival of the leading end of the sheet P, to the sheet processing controller 210. Similarly to the entrance sensor 24, the skew sensor 21, the sheet detection sensor 22, and the sheet detection sensor 26 described above, a known sensor can be used as an example of the circulation sensor 25.

In the present embodiment, a second sheet conveyor includes the first forward-reverse roller 13 and the pressing roller 14, and a folding portion former includes the first folding roller 12 and the first forward-reverse roller 13. Further, in the present embodiment, another folding portion former includes the first forward-reverse roller 13 and the second folding roller 15.

Flow of Folding Process A description is given below of a flow and operations of the folding process to form a folding portion on a sheet P by the sheet folder unit 200.

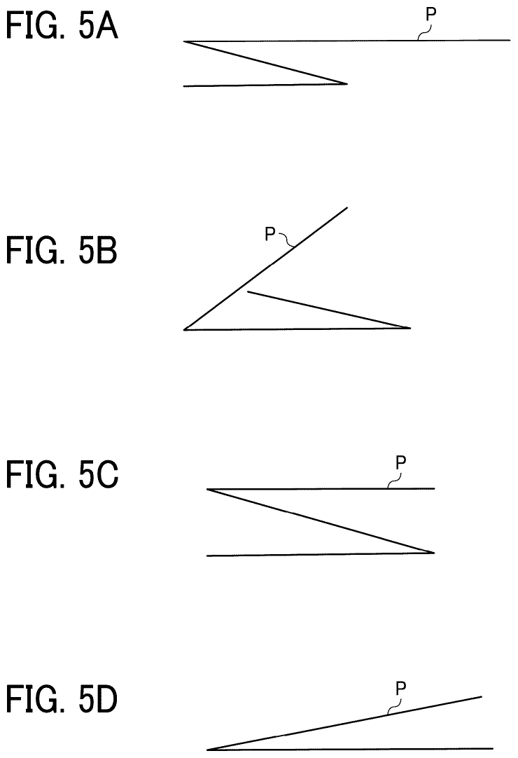

FIGS. 5A, 5B, 5C and 5D are diagrams illustrating examples of folding patterns formed by the sheet folding operation executable by the sheet folder unit 200 according to the present embodiment.

The sheet folder unit 200 according to the present embodiment performs operations of forming two fold-out portions on the sheet P, so that the folding as illustrated in FIG. 5A is made. The folding of forming two fold-out portions as illustrated in FIG. 5A may be referred to as a “Z-fold”. In other words, the sheet folder unit 200 can perform a Z-folding operation. Further, the sheet folder unit 200 can form two fold-in portions on substantially a trisection of the sheet P in the length direction, so that the folding as illustrated in FIG. 5B is made. In other words, the sheet folder unit 200 can perform a letter fold-in operation of folding the sheet P in a letter fold-in manner. Further, the sheet folder unit 200 can form two fold-out portions on substantially a trisection of the sheet P, so that the folding as illustrated in FIG. 5C is made. In other words, the sheet folder unit 200 can perform a letter fold-out operation of folding the sheet P in a letter fold-out manner. Further, the sheet folder unit 200 can form one folding portion on substantially a bisection of the sheet P, so that the folding as illustrated in FIG. 5D is made. In other words, the sheet folder unit 200 can perform a half-fold operation of folding the sheet P in a half-fold manner.

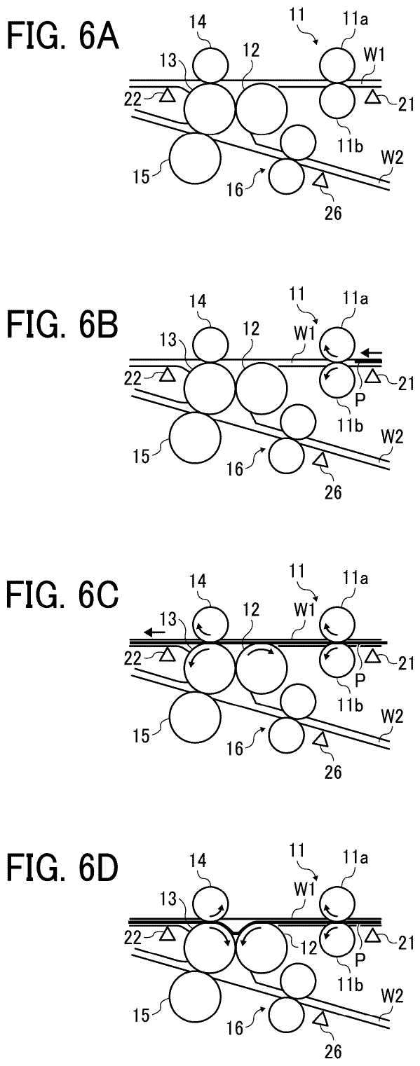

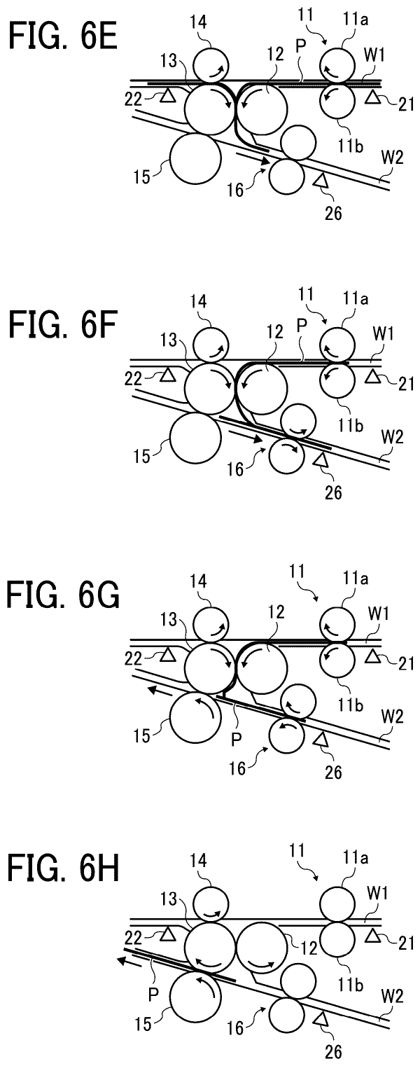

FIGS. 6A, 6B, 6C, 6D, 6E, 6F, 6G and 6H are diagrams illustrating a typical operation when the sheet folder unit 200 performs a Z-folding operation.

The sheet P is conveyed from an ejection roller in the image formation unit 100 to the entrance roller pair 10, and is conveyed by a conveyance force applied by the entrance roller pair 10 in a given direction. The given direction may be referred to as “forward conveyance”. The leading end of the sheet P is first detected by the skew sensor 21. The controller that has received the leading end detection signal output from the skew sensor 21 controls the skew forward-reverse motor 11m to start rotating the skew correction roller pair 11 (see FIGS. 6A and 6B).

Subsequently, when the leading end of the sheet P enters the nip region of the skew correction roller pair 11, the conveyance force of the skew correction roller pair 11 is also applied to the sheet P, so that the sheet P is conveyed toward the exit of the non-folding conveyance path W1. The sheet P conveyed in the non-folding conveyance path W1 enters into the nip region of the first forward-reverse roller 13 and the pressing roller 14. After passing through the nip region, the leading end of the sheet P is detected by the sheet detection sensor 22. The controller that has received the leading end detection signal from the sheet detection sensor 22 executes the following control. Specifically, when the leading end of the sheet P protrudes from the position of the nip position between the first forward-reverse roller 13 and the pressing roller 14 by a predetermined protrusion amount (see FIG. 6C), the controller causes the first forward-reverse motor 13m to stop the rotation of the first forward-reverse roller 13. At the same time, the controller causes the skew forward-reverse motor 11m to stop the rotation of the drive roller 11b of the skew correction roller pair 11.

The protrusion amount at this time is appropriately determined depending on the length of the sheet P in the sheet conveyance direction and how the sheet P is folded (such as the folding pattern). The protrusion amount of the leading end of the sheet P can be grasped from, for example, the reception timing of the leading end detection signal that is output from the sheet detection sensor 22 and the amount of rotation of the pressing roller 14.

Subsequently, the controller causes the first forward-reverse motor 13m to start the reverse rotation of the first forward-reverse roller 13 in a direction in which the sheet P returns to the entrance side of the non-folding conveyance path W1, and causes the skew forward-reverse motor 11m to start the rotation of the skew correction roller pair 11. By so doing, a bend is formed on the portion of the sheet between the skew correction roller pair 11 and the first forward-reverse roller 13 (see FIG. 6D).

This bend portion, which is also called a folded-back portion, of the sheet P enters the nip region of the first folding roller 12 and the first forward-reverse roller 13 to form a first folded portion in the folded-back portion. As the first folded portion of the sheet P, which has passed through the nip region between the first folding roller 12 and the first forward-reverse roller 13, enters the branched conveyance path W2 (see FIG. 6E). Then, the sheet P is conveyed in the branched conveyance path W2 toward the second forward-reverse roller pair 16.

The first folded portion of the sheet P enters the nip region of the second forward-reverse roller pair 16. After passing through the nip region, the first folded portion of the sheet P is detected by the sheet detection sensor 26. The controller that has received the leading end detection signal from the sheet detection sensor 26 executes the following control. Specifically, when the first folded portion of the sheet P protrudes from the position of the nip position of the second forward-reverse roller pair 16 by a predetermined protrusion amount (see FIG. 6F), the controller causes the first forward-reverse motor 13m to stop the rotation of the first forward-reverse roller 13.

At the same time, the controller causes the second forward-reverse motor 16m and the skew forward-reverse motor 11m to stop the rotation of the second forward-reverse roller pair 16 and the rotation of the skew correction roller pair 11, respectively. Similarly to the protrusion amount described above, the protrusion amount at this time is appropriately determined depending on the length of the sheet P in the sheet conveyance direction and how the sheet P is folded (such as the folding pattern). The protrusion amount of the first folded portion of the sheet P can be grasped from, for example, the reception timing of the leading end detection signal that is output from the sheet detection sensor 26 and the amount of rotation of the second forward-reverse roller pair 16.

Subsequently, the controller causes the second forward-reverse motor 16m to start the reverse rotation of the second forward-reverse roller pair 16 in a direction in which the sheet P is conveyed to the exit side of the branched conveyance path W2 and, at the same time, causes the first forward-reverse motor 13m and the skew forward-reverse motor 11m to start again the reverse rotation of the first forward-reverse roller 13 and the rotation of the skew correction roller pair 11, respectively. By so doing, a bend is formed on the portion of the sheet P between the first forward-reverse roller 13 and the second forward-reverse roller pair 16 (see FIG. 6G). This bend portion (folded-back portion) of the sheet P enters the nip region of the first forward-reverse roller 13 and the second folding roller 15 to form a second folded portion in the folded-back portion of the sheet P.

As the second folded portion of the sheet P that has passed through the nip region between the first forward-reverse roller 13 and the second folding roller 15 is conveyed in the branched conveyance path W2 toward the exit side (see FIG. 6H). The sheet P on which the two folded portions are formed as described above receives the conveyance force of the first forward-reverse roller 13 to be conveyed to the post-processing apparatus 3 downstream from the sheet folder unit 200 in the sheet conveyance direction.

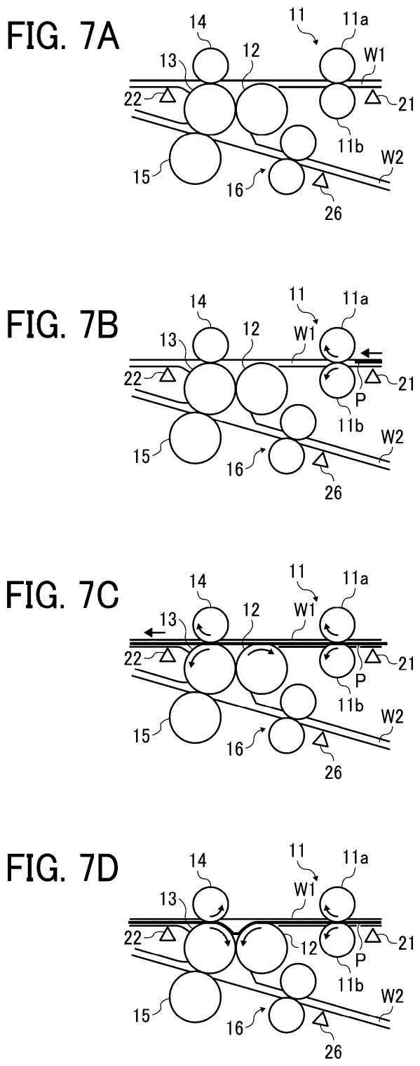

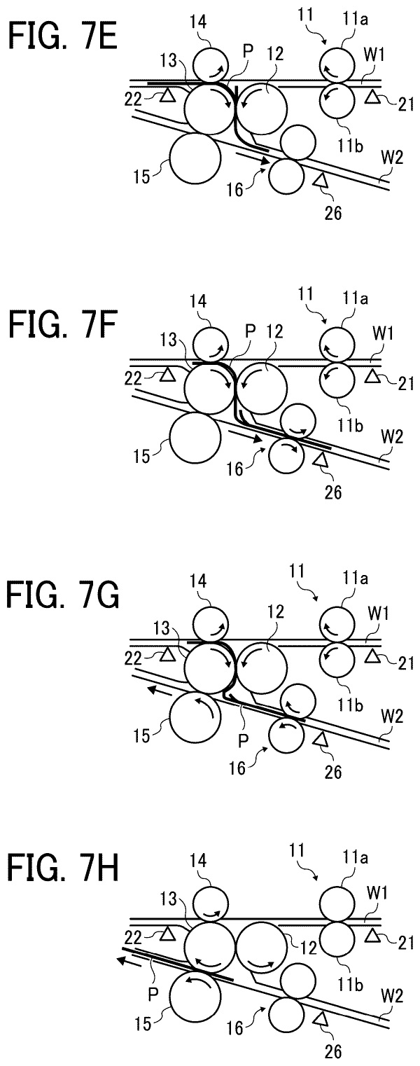

FIGS. 7A, 7B, 7C, 7D, 7E, 7F, 7G and 7H are diagrams illustrating a typical operation when the sheet folder unit 200 performs a letter fold-in operation.

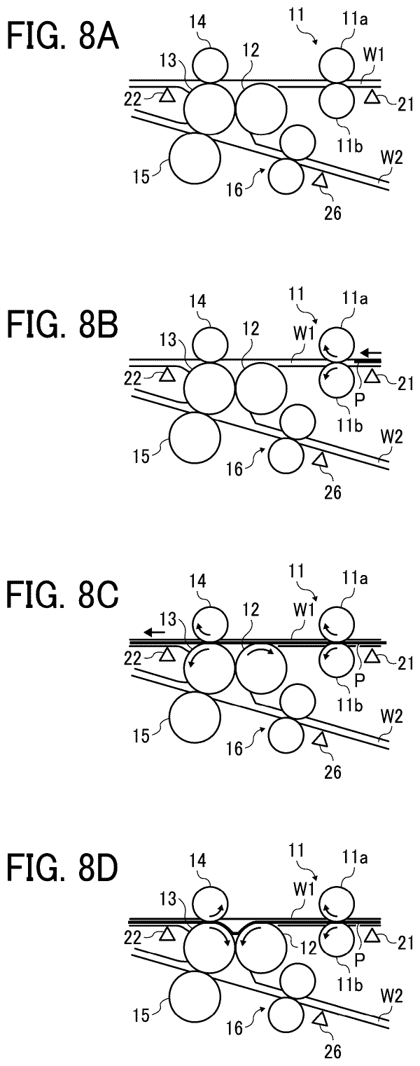

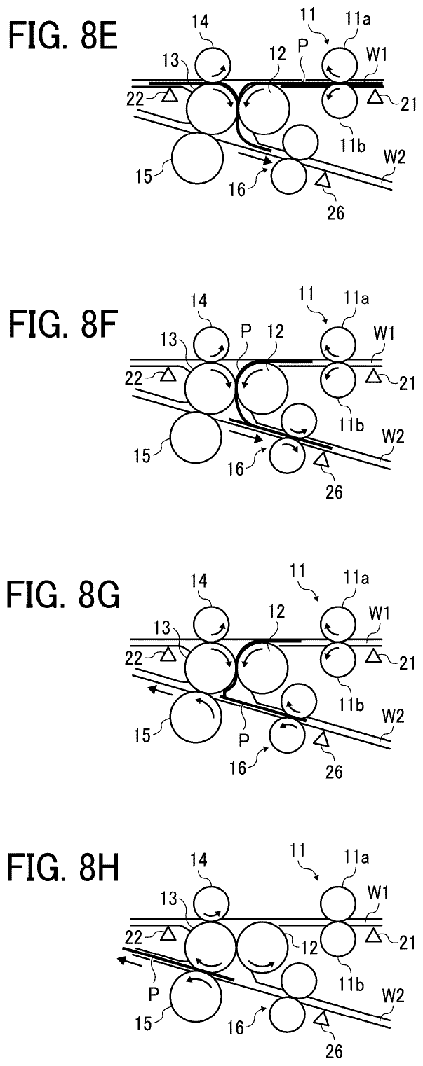

FIGS. 8A, 8B, 8C, 8D, 8E, 8F, 8G and 8H are diagrams illustrating a typical operation when the sheet folder unit 200 performs a letter fold-out operation.

The operation flows of the letter fold-in operation and the letter fold-out operation are the same as the above-described operation flow of the Z-folding operation. However, the protrusion amounts of the letter fold-in operation and the letter fold-out operation are different from the protrusion amount of the Z-folding operation. Accordingly, the Z-folding operation, the letter fold-in operation, and the letter fold-out operation have different timings to start the reverse rotations of the first forward-reverse roller 13 and the second forward-reverse roller pair 16.

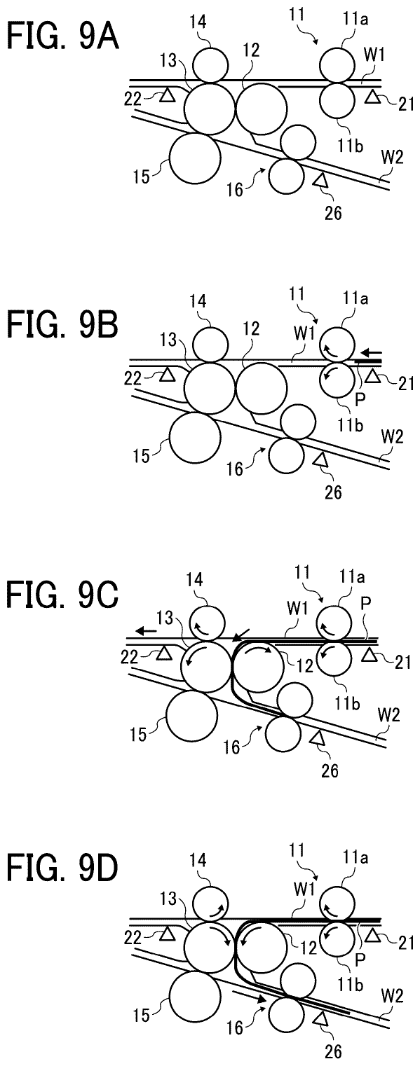

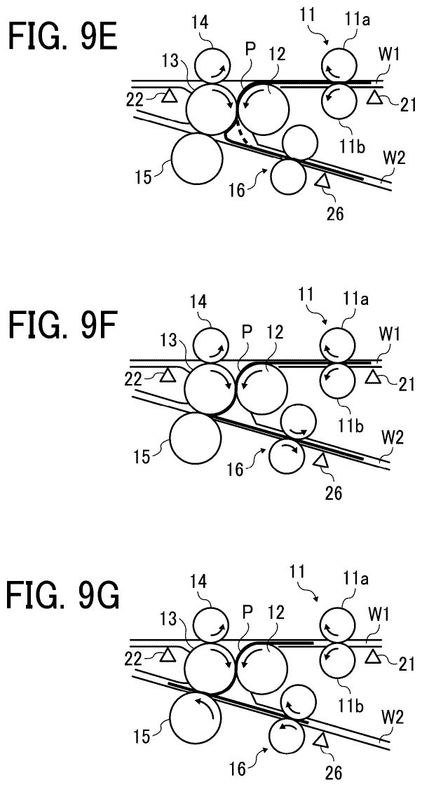

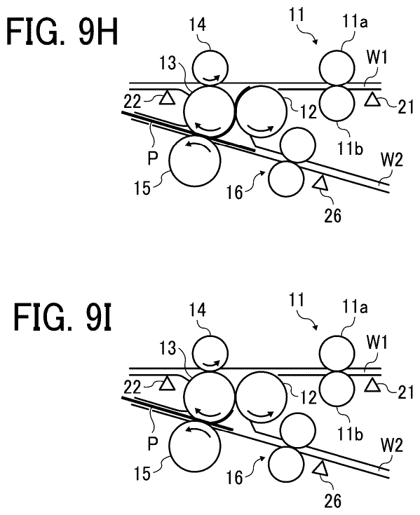

FIGS. 9A, 9B, 9C, 9D, 9E, 9F, 9G, 9H and 9I are diagrams illustrating a typical operation when the sheet folder unit 200 performs a half-fold operation.

The half-fold operation basically the same operation flow as the operation flow of the Z-folding operation. The half-fold operation is different from the Z-folding operation in that the leading end of the sheet P conveyed in the non-folding conveyance path W1 does not enter the nip region between the first forward-reverse roller 13 and the pressing roller 14 but enters the nip region between the first folding roller 12 and the first forward-reverse roller 13. Further, the half-fold operation uses a projection amount A2 that is different from the projection amount used in the Z-folding operation. In the half-fold operation, the first forward-reverse roller 13 and the pressing roller 14 correspond to a first conveyor, and the second forward-reverse roller pair 16 corresponds to a second conveyor. Further, the half-fold operation may be performed by a first folding portion former 20a.

### Multiple-Sheet Folding Process

A description is now given of a multiple-sheet folding process executable in the sheet folder unit 200. In the present embodiment, multiple sheets can be overlaid and folded.

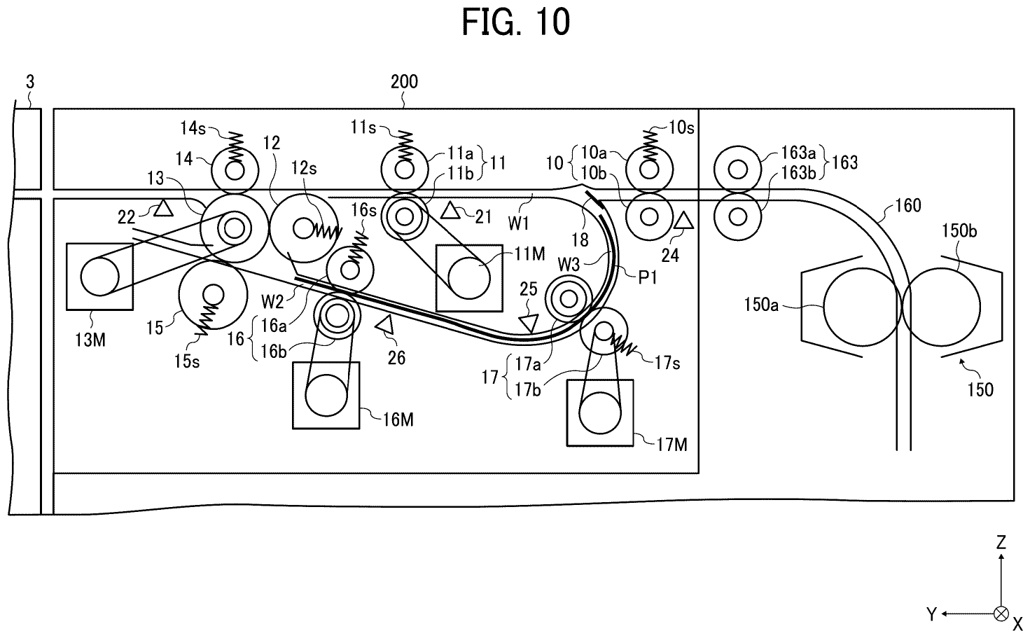

FIGS. 10, 11, 12, 13, 14 and 15 are diagrams illustrating an internal configuration of the sheet folder unit 200 for explaining the operation of a multiple-sheet folding process executed by the sheet folder unit 200.

FIG. 10 illustrates the sheet folder unit 200 in a state in which a preceding sheet (first sheet) P1 is conveyed by the circulating conveyance roller pair (the second skew correction roller pair 17) to a meeting point of the circulating conveyance path W3 and the non-folding conveyance path W1 and waits for a subsequent sheet P2.

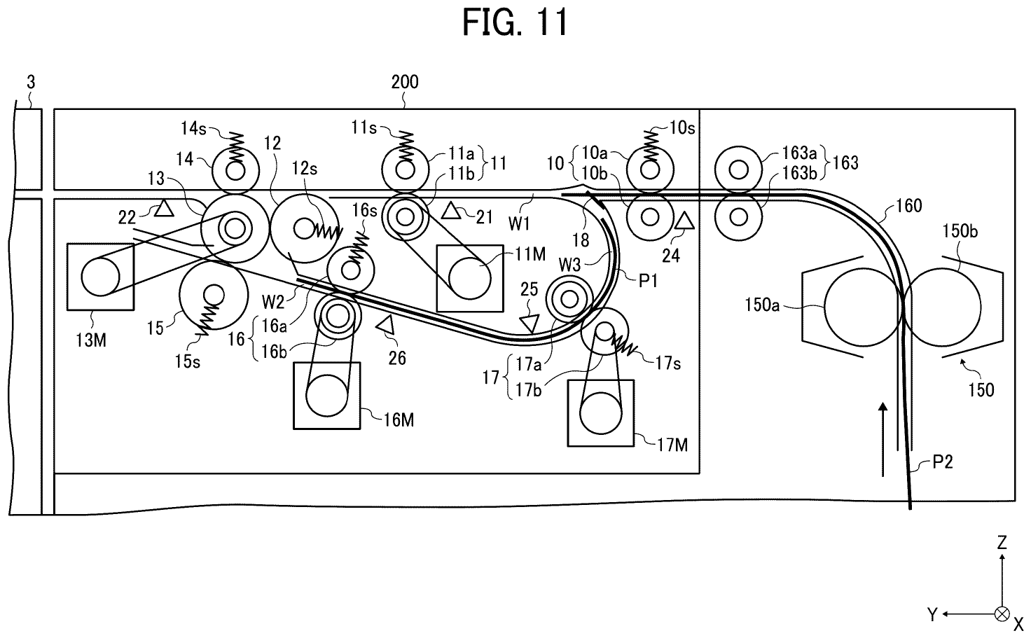

From this state, as the subsequent sheet P2 is detected by the entrance sensor 24 and then conveyed by a designated distance, the preceding sheet P1 is conveyed by the circulating conveyance roller pair (the second skew correction roller pair 17) again (see FIG. 11).

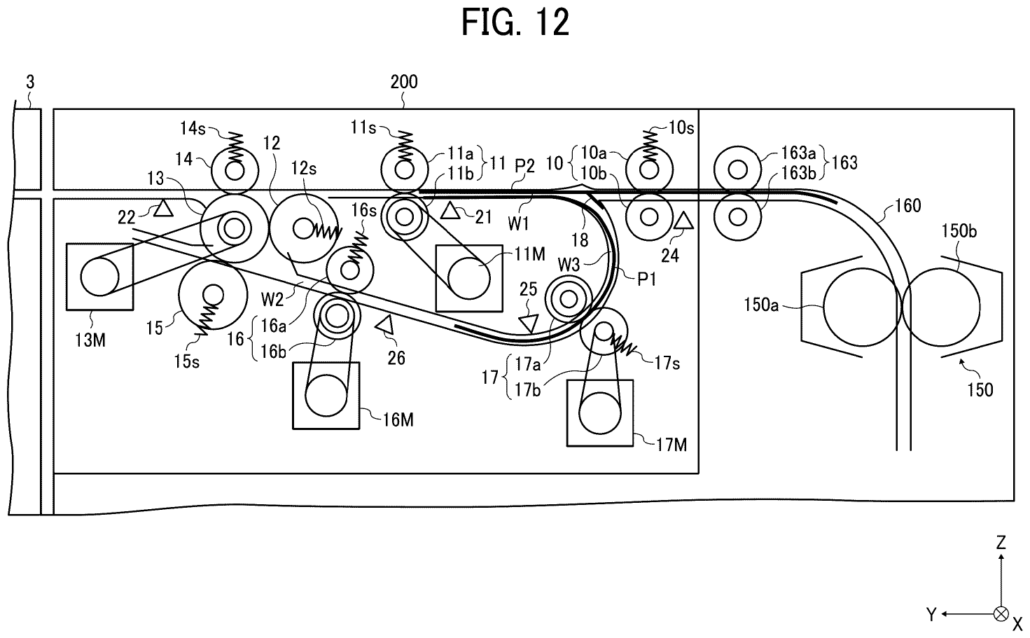

Then, the preceding sheet P1 is overlaid on the subsequent sheet P2 in the non-folding conveyance path W1, and is conveyed with the subsequent sheet P2 to the skew correction roller pair 11. The leading ends of the overlaid sheets P1 and P2 contact in the nip region of the skew correction roller pair 11 as a leading-end-alignment conveyance roller pair. By so doing, both skew of the two sheets P1 and P2 and displacement of the leading ends of the sheets P1 and P2 are corrected (see FIG. 12).

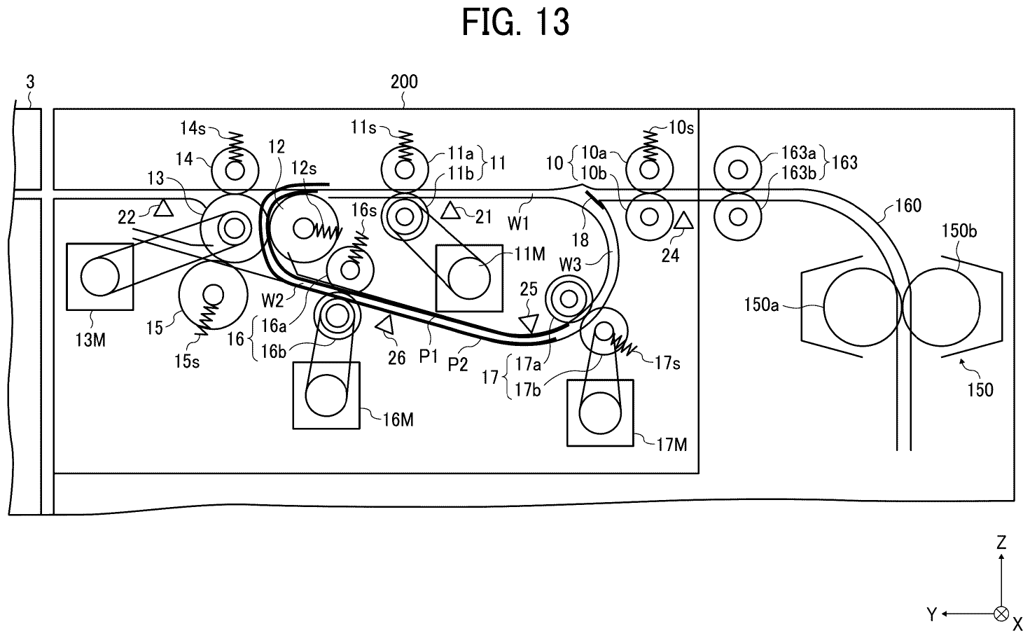

From the nip region of the skew correction roller pair 11, the two overlaid sheets P1 and P2 are conveyed to the circulating conveyance path W3. When the overlaid sheets P1 and P2 are conveyed to the circulating conveyance path W3, the preceding sheet P1 that passes an inner conveyance route relative to the subsequent sheet P2 in the circulating conveyance path W3 and the subsequent sheet P2 that passes an outer conveyance route relative to the preceding sheet P1 in the circulating conveyance path W3 have a difference in the distance of conveyance such as a turning radius difference (in other words, a difference between track followed by front and back inner wheels of a vehicle). For this reason, the leading ends of the overlaid sheets P1 and P2 are displaced from each other, in other words, misaligned (see FIG. 13).

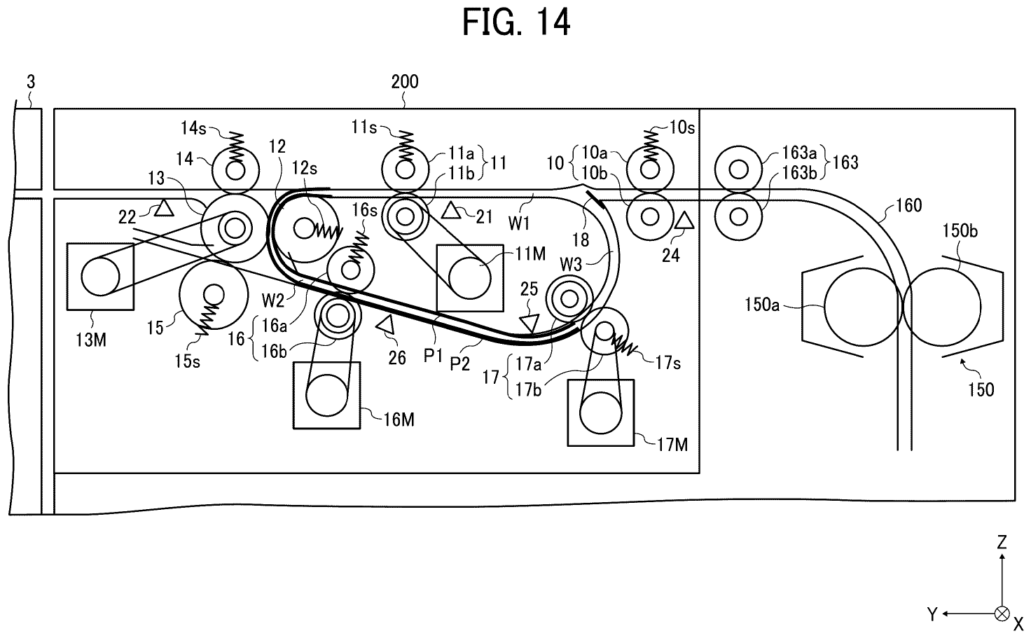

The leading ends of the two sheets P1 and P2 contact the nip region of the second skew correction roller pair 17 that is one of circulating conveyance roller pairs as a circulating conveyor. By so doing, the displacement (misalignment) of the leading ends of the sheets P1 and P2 can be corrected (see FIG. 14).

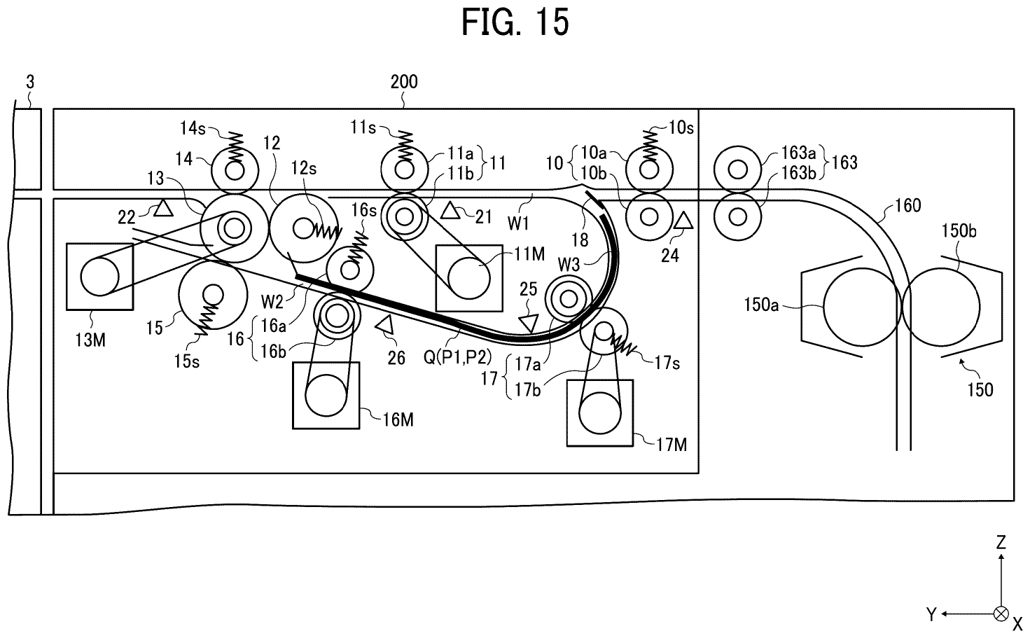

The two sheets P1 and P2 whose leading ends have been corrected by the second skew correction roller pair 17 are returned from the circulating conveyance path W3 to the non-folding conveyance path W1 (see FIG. 15).

Then, in the skew correction roller pair 11, another subsequent sheet (third sheet) is further overlaid on the two sheets P1 and P2, and the leading ends of the two sheets P1 and P2 and the subsequent sheet (third sheet) are aligned.

As described above, the sheet folder unit 200 according to the present embodiment can achieve the effect especially when the sheet folder unit 200 performs a folding operation on three or more overlaid sheets P.

More specifically, the sheet folder unit 200 according to the present embodiment is effective when performing the multiple-sheet folding process after the first sheet P1 is firstly conveyed, the second sheet P2 that is conveyed after the first sheet P1 is then overlaid on the first sheet P1, the first sheet P1 and the second sheet P2 overlaid with each other contact the nip region of the skew correction roller pair 11, and the leading ends of the first sheet P1 and the second sheet P2 are aligned.

In other words, to correct the misalignment of the leading ends of the overlaid two sheets P1 and P2 caused by the two sheets P1 and P2 whose leading end positions are aligned by the skew correction roller pair 11 being conveyed to the circulating conveyance path W3, the leading end alignment is performed again by the second skew correction roller pair 17 disposed on the downstream side of the circulating conveyance path W3 in the sheet conveyance direction. Then, multiple sheets subjected to the leading end alignment in the circulating conveyance path W3 are returned to the non-folding conveyance path W1, so that the leading ends of the multiple sheets and the leading end of a new sheet (third sheet P3) are further aligned. At this time, the leading ends of the first sheet P1 and the second sheet P2 subjected to the leading end alignment and the leading end of the third sheet P3 contact to perform the leading end alignment in the nip region of the skew correction roller pair 11.

The multiple sheet folding process performed by the sheet processing controller 210 according to the present embodiment as described above can fold the medium with the leading ends of multiple sheets P being aligned.

### Aspects of the Present Disclosure

Aspects of the present disclosure are, for example, as follows.

### Aspect 1

In Aspect 1, a medium processing apparatus includes a conveyor disposed in a conveyance path in which a medium is conveyed from an upstream side toward a downstream side in a conveyance direction, and a circulating conveyor disposed in a circulating conveyance path in which the medium is branched from the conveyance path and is returned to the upstream side of the conveyance path. At least one conveyance roller pair of multiple conveyance roller pairs disposed in the circulating conveyance path includes a displacement-correction conveyance roller pair to correct multiple media overlaying displacements generated by the circulating conveyance path.

### Aspect 2

In Aspect 2, in the medium processing apparatus according to Aspect 1, at least one conveyance roller pair of the multiple conveyance roller pairs disposed in the conveyance path includes a leading-end-alignment conveyance roller pair that brings media conveyed from an upstream side in a conveyance direction and match respective leading ends of the media.

### Aspect 3

In Aspect 3, in the medium processing apparatus according to Aspect 2, the leading-end-alignment conveyance roller pair is downstream from a position at which the circulating conveyance path returns to the conveyance path.

### Aspect 4

In Aspect 4, in the medium processing apparatus according to any one of Aspects 1 to 3, the displacement-correction conveyance roller pair of the conveyance roller pairs disposed in the circulating conveyance path is upstream from a position at which the circulating conveyance path returns to the conveyance path.

### Aspect 5

In Aspect 5, in the medium processing apparatus according to any one of Aspects 1 to 4, multiple conveyance roller pairs disposed in the conveyance path, and multiple conveyance roller pairs disposed in the circulating conveyance path perform an overlaying operation of overlaying the multiple media and a folding operation of folding the multiple media overlaid on one another.

### Aspect 6

In Aspect 6, an image forming apparatus includes an image forming device that forms an image on a medium, the medium processing device, according to any one of Aspects 1 to 5, that performs a given process on the medium.

### Aspect 7

In Aspect 7, an image forming system includes an image forming apparatus including an image forming device that forms an image on a medium, and the medium processing apparatus according to any one of Aspects 1 to 5, coupled to the image forming apparatus.

### Aspect 8

In Aspect 8, a medium processing apparatus includes a first conveyor and a second conveyor. The first conveyor is disposed in a conveyance path to convey a medium or multiple media including the medium in a conveyance direction. The second conveyor is disposed in a circulation path that is branched from the conveyance path at a branching point and is merged at a merging point upstream from the branching point in the circulation path in the conveyance direction to circulate the medium. The second conveyor includes a correction roller pair to correct a displacement of the multiple media that are overlaid on each other and circulate together in the circulation path.

### Aspect 9

In Aspect 9, in the medium processing apparatus according to Aspect 8, the first conveyor includes multiple conveyance roller pairs including a leading-end alignment roller pair to overlay another medium conveyed to the conveyance path from an apparatus upstream from the medium processing apparatus in the conveyance direction, on the medium (P1) to form the multiple media, and align a leading end of the medium and a leading end of said another medium.

### Aspect 10

In Aspect 10, in the medium processing apparatus according to Aspect 9, the leading-end alignment roller pair is downstream from the merging point in the conveyance path, to which the circulation path merges, in the conveyance direction.

### Aspect 11

In Aspect 11, in the medium processing apparatus according to any one of Aspects 8 to 10, the correction roller pair is upstream from the merging point in the conveyance path, to which the circulation path merges, in the conveyance direction.

### Aspect 12

In Aspect 12, the medium processing apparatus according to any one of Aspects 8 to 11, the first conveyor includes multiple first conveyance roller pairs, and the second conveyor includes multiple second conveyance roller pairs. The multiple first conveyance roller pairs of the first conveyor and the multiple second conveyance roller pairs of the second conveyor overlay the medium and another medium to form the multiple media, and perform a given sheet folding operation on the multiple media including the medium and said another medium overlaid with each other.

### Aspect 13

In Aspect 13, an image forming apparatus includes an image forming device that forms an image on a medium, the medium processing device, according to any one of Aspects 8 to 12, that performs a given process on the medium.

### Aspect 14

In Aspect 14, an image forming system includes an image forming apparatus including an image forming device that forms an image on a medium, and the medium processing apparatus according to any one of Aspects 8 to 12, detachably attachable to the image forming apparatus.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such modifications are also included in the technical scope of the present disclosure.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a first conveyor, in a conveyance path, to convey a medium or multiple media including the medium in a conveyance direction; and
a second conveyor disposed in a circulation path that is branched from the conveyance path at a branching point and is merged at a merging point upstream from the branching point in the circulation path in the conveyance direction to circulate the medium,
wherein the second conveyor includes a correction roller pair to correct a displacement of the multiple media that are overlaid on each other and circulate together in the circulation path.

2. The medium processing apparatus according to claim 1,
wherein the first conveyor includes multiple conveyance roller pairs including a leading-end alignment roller pair to:
overlay another medium conveyed to the conveyance path from an apparatus upstream from the medium processing apparatus in the conveyance direction, on the medium to form the multiple media; and
align a leading end of the medium and a leading end of said another medium.

3. The medium processing apparatus according to claim 2,
wherein the leading-end alignment roller pair is downstream from the merging point in the conveyance path, to which the circulation path merges, in the conveyance direction.

4. The medium processing apparatus according to claim 1,
wherein the correction roller pair is upstream from the merging point in the conveyance path, to which the circulation path merges, in the conveyance direction.

5. The medium processing apparatus according to claim 1,
wherein the first conveyor includes multiple first conveyance roller pairs,
the second conveyor includes multiple second conveyance roller pairs, and
the multiple first conveyance roller pairs of the first conveyor and the multiple second conveyance roller pairs of the second conveyor:
overlay the medium and another medium to form the multiple media; and
perform a given sheet folding operation on the multiple media including the medium and said another medium overlaid with each other.

6. An image forming apparatus comprising:
an image forming device to form an image on a medium; and
the medium processing apparatus according to claim 1 to perform a given operation on the medium.

7. An image forming system comprising:
an image forming apparatus to form an image on a medium; and
the medium processing apparatus according to claim 1 detachably attachable to the image forming apparatus.
